(19) United States
(12) Patent Application Publication
(10) Pub. No.: US 2020/0263471 A1
(43) Pub. Date: Aug. 20, 2020

(54) PIVOT HINGE APPARATUS FOR DOOR

(71) Applicant: Yongjun JO, Yongin-si (KR)

(72) Inventor: Yongjun JO, Yongin-si (KR)

(21) Appl. No.: 16/779,697

(22) Filed: Feb. 3, 2020

(30) Foreign Application Priority Data
Feb. 14, 2019 (KR) 10-2019-0017169

(51) Int. Cl. E05F 3/20; E05F 3/10

(52) U.S. Cl. CPC E05F 3/20; E05Y 2201/638; E05Y 2900/132; E05F 3/104

(57) ABSTRACT

Disclosed herein is a pivot hinge apparatus for a door. The pivot hinge apparatus includes a torsion device configured to be mounted on a doorframe. The torsion device includes: a first cam member formed such that first and second sliding portions configured to provide guiding through vertical sliding with respect to rotation movement are disposed in upper and lower directions; and a second cam member disposed to be slidable vertically by rotation relative to the first cam member by a third sliding portion that comes into contact with the first sliding portion and configured to restrain the third sliding portion and the first sliding portion from being separated from each other in such a manner that a fourth sliding portion is guided to the second sliding portion.

### CROSS-REFERENCE TO RELATED APPLICATION

This application claims the benefit of Korean Patent Application No. 10-2019-0017169 filed on Feb. 14, 2019, which is hereby incorporated by reference herein in its entirety.

### BACKGROUND

### 1. Technical Field

The present invention relates generally to a pivot hinge apparatus for a door, and more specifically to a pivot hinge apparatus for a door, in which even when both a torsion device and a damping device are implemented by adding them to each other, a state in which a first cam unit and a second cam unit are engaged with each other is maintained despite a difference in speed attributable to damping force, and thus they are prevented from running idle, with the result that damping force is accurately transferred to a door, thereby improving the reliability of the operation of opening and closing the door.

### 2. Description of the Related Art

Generals, a hinge apparatus is a component that is installed on a rotating shaft of a rotating object such as a door and enables the door or the like to be installed in the state of being smoothly rotatable. Such a hinge apparatus usually includes a pivot hinge for easily rotating a heavy door about its vertical axis. The pivot hinge may use a bearing for smoothly performing the opening and closing operation of the door or the like.

As a technology related to a conventional hinge apparatus for a door, Korean Patent Application Publication No. 10-2013-0021520 discloses a “Door Hinge Apparatus with a Rotating Cam having Improved Wear Resistance.” The door hinge apparatus with a rotating cam having improved wear resistance includes: a housing having a receiving portion; a shaft inserted into the housing; a rotating cam accommodated in the accommodation portion of the housing while being penetrated by the shaft and rotating together with the shaft; a slide cam accommodated in the accommodation portion of the housing while being penetrated by the shaft and sliding according to the rotation of the rotating cam; a spring accommodated in the housing of the housing while being penetrated by the shaft and providing a restoring force to the slide cam; and a cover configured to seal the housing. The slide cam is made of a synthetic resin material, and the rotating cam is made of a synthetic resin material, the rotating cam body is made of a metal material and includes a rotating cam body provided with a seat groove on one side thereof and a rotating cam bushing made of a metal material, provided with a through hole, and inserted into the seat groove.

However, the conventional technology may cause a problem in that the rotating cam and the slide cam may be separated from each other, and thus the opening and closing speed of the door may be suddenly changed due to their gap during operation. In particular, when a damping device is added, the gap between the rotating cam and the slide cam must occur due to a difference in speed attributable to damping force, which causes the rotating cam and the slide cam to run idle, so that the door is excessively rapidly closed in a specific section. Therefore, problems arise in that inconvenience is caused to a user and the safety of use of the door is impaired.

### SUMMARY

The present invention has been conceived to overcome the above-described problems, and an object of the present invention is to provide a pivot hinge apparatus for a door, in which restoring force for closing is accurately transferred to the door, thereby improving the reliability of door operation, and in which even when both a torsion device and a damping device are implemented by adding them to each other, a state in which a first cam unit and a second cam unit are engaged with each other is maintained despite a difference in speed attributable to damping force, and thus they are prevented from running idle, with the result that damping force is accurately transferred to the door, thereby improving the reliability of the operation of opening and closing the door and also providing safe use as well as convenient use to a user.

Other objects of the present invention will be readily understood from the following description of embodiments.

In order to accomplish the above object, the present invention provides a pivot hinge apparatus for a door, the pivot hinge apparatus including a torsion device configured to be mounted on a doorframe, wherein the torsion device includes: a first cam member formed such that first and second sliding portions configured to provide guiding through vertical sliding with respect to rotation movement are disposed in upper and lower directions; and a second cam member disposed to be slidable vertically by rotation relative to the first cam member by a third sliding portion that comes into contact with the first sliding portion and configured to restrain the third sliding portion and the first sliding portion from being separated from each other in such a manner that a fourth sliding portion is guided to the second sliding portion.

The pivot hinge apparatus may further include a casing disposed in the doorframe and configured such that the torsion device is disposed therein, and the torsion device may be fastened to a door stile by a fastening shaft provided on the first cam member and protruding to one end and generate restoring force by a spring so that the door is closed.

The torsion device may further include: a fastening member coupled to an end of the casing, fastened to an end of the doorframe, and configured such that the fastening shaft protrudes therefrom; a connection shaft coupled to the second cam member, and configured to extend vertically; and a spring installed on the connection shaft in order to provide elastic force to the second cam member.

The fastening member may be provided with a mounting portion configured to perform mounting via a bearing so that the first cam member allows the fastening shaft to protrude, and the casing may be fastened in the state of having been inserted into the outside of the mounting portion.

The first cam member may be configured such that the fastening shaft is provided to be perpendicular to one end thereof, a mounting groove open at a remaining end thereof may be formed through the center thereof, a first sliding portion including an inclined sliding surface may be provided at the remaining end, and a second sliding portion stacked on the first sliding portion and including an inclined sliding surface may be formed to open the mounting groove.

The second cam member may include: a connection body provided with an inclined third sliding portion at one end thereof to come into contact with the first sliding portion; and an insertion shaft provided to protrude from one end of the connection body, coupled onto the mounting groove to be slidable, and configured to apply braking for a difference in speed attributable to damping force in such a manner that the fourth sliding portion protruding through a side comes into contact with the second sliding portion.

The pivot hinge apparatus may further include a damping device installed in the casing in order to provide damping force to the connection shaft, and the damping device may include: a damping housing part filled with a working fluid, provided with first and second sealing parts at both ends thereof in order to achieve sealing, and fastened in the casing; a piston inserted into the damping housing part through the second sealing part, provided with a head in order to receive pressure of the working fluid, and connected to the connection shaft; a damping chamber configured such that a body into which the head is inserted is fastened to an inside of the damping housing part, an internal space of the body is divided into first and second spaces in contact with the first and second sealing parts by the head, a main passage connecting the first and second spaces to each other is formed and provides a working fluid path between the first and second spaces to achieve damping, and a mounting groove is formed through an outer surface of the body; and a one-way control unit configured to allow the main passage to be blocked by a ball seated in the main passage from an outside, and to allow the working fluid to move in one direction between the first and second spaces while the piston moves in such a manner that an elastic portion configured to elastically support the ball to be seated in the main passage is mounted in the mounting groove.

The piston may be configured such that both ends thereof are slidably coupled to the first and second sealing parts, the head is slidably coupled to a piston rod, the head is fastened to be restrained by the fastening member from moving in such a manner that fastening members are fitted into fitting grooves formed in both sides of the head in the piston rod, a bypass passage configured to connect both sides of the head to each other is formed to bypass the head, and a degree of opening of the bypass passage is adjusted by a damping adjustment bolt screw-coupled to one end exposed from the first sealing part.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a perspective view showing a doorframe and a door stile on which a pivot hinge apparatus for a door according to an embodiment of the present invention is installed;

FIG. 2 is a perspective view showing a state in which the pivot hinge apparatus for a door according to the embodiment of the present invention is installed;

FIG. 3 is an exploded perspective view showing the pivot hinge apparatus for a door according to the embodiment of the present invention;

FIG. 4 is an enlarged exploded perspective view showing the torsion device shown in FIG. 3;

FIG. 5 is an enlarged exploded perspective view showing the damping device shown in FIG. 3;

FIG. 6 is a perspective view showing the important portion of the damping device in the pivot hinge apparatus for a door according to the embodiment of the present invention;

FIG. 7 is an exploded perspective view showing the important portion of the damping device in the pivot hinge apparatus for a door according to the embodiment of the present invention;

FIG. 8 is an exploded perspective view showing the important portion of the damping device in the pivot hinge apparatus for a door according to the embodiment of the present invention in a different direction;

FIG. 9 is a side view showing the pivot hinge apparatus for a door according to the embodiment of the present invention in the state in which a door is closed;

FIG. 10 is a sectional view showing the pivot hinge apparatus for a door according to the embodiment of the present invention in the state in which the door is closed;

FIG. 11 is a side view showing the pivot hinge apparatus for a door according to the embodiment of the present invention in the state in which the door is opened by 10 degrees;

FIG. 12 is a sectional view showing the pivot hinge apparatus for a door according to the embodiment of the present invention in the state in which the door is opened by 10 degrees;

FIG. 13 is a side view showing the pivot hinge apparatus for a door according to the embodiment of the present invention in the state in which the door is opened by 30 degrees;

FIG. 14 is a sectional view showing the pivot hinge apparatus for a door according to the embodiment of the present invention in the state in which the door is opened by 30 degrees;

FIG. 15 is a side view showing the pivot hinge apparatus for a door according to the embodiment of the present invention in the state in which the door is opened by 90 degrees; and

FIG. 16 is a sectional view showing the pivot hinge apparatus for a door according to the embodiment of the present invention in the state in which the door is opened by 90 degrees.

### DETAILED DESCRIPTION

Various modifications may be made to the present invention, and the present invention may have various embodiments. Specific embodiments will be illustrated in the accompanying drawings and described in detail. However, this does not intend to limit the present invention to the specific embodiments, but it should be appreciated that all modifications, equivalents and substitutions included in the technical spirit and scope of the present invention are included in the present invention. The scope of the present invention is not limited to the following embodiments.

Embodiments of the present invention will be described in detail below with reference to the accompanying drawings. The same reference numerals will be assigned to the same or corresponding components regardless of the drawings, and redundant descriptions thereof will be omitted.

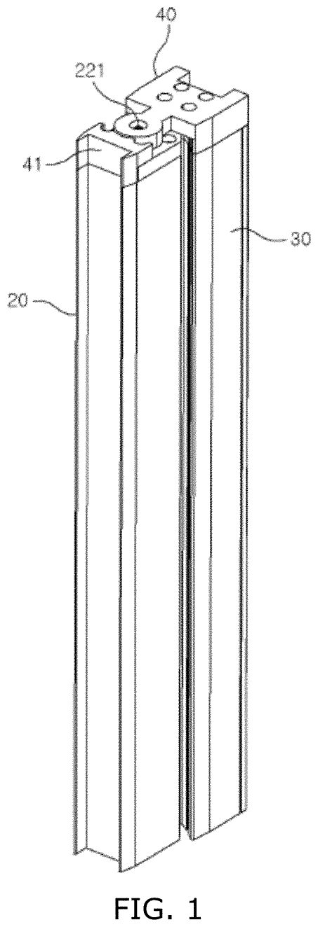

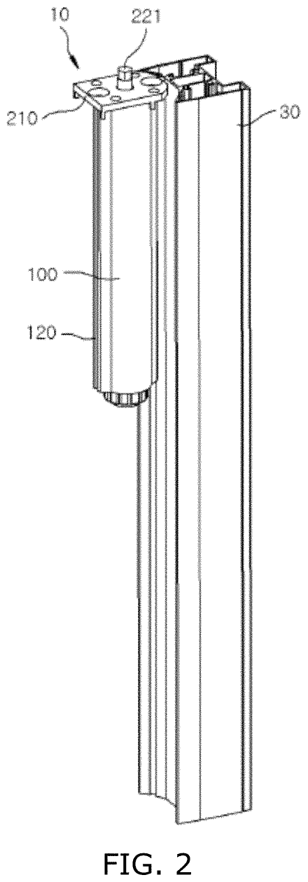

FIG. 1 is a perspective view showing a doorframe and a door stile on which a pivot hinge apparatus for a door according to an embodiment of the present invention is installed, and FIG. 2 is a perspective view showing a state in which the pivot hinge apparatus for a door according to the embodiment of the present invention is installed.

Referring to FIGS. 1 and 2, a pivot hinge apparatus 10 for a door according to an embodiment of the present invention is installed, for example, in the upper portion of a doorframe 20 that is provided in parallel with a door. A fastening shaft 221 may protrude upward to be connected to a door stile 30 that forms an opening through the opening and closing of a door. The fastening shaft 221 may be connected to the upper end of the door stile 30 by a bracket 40, and may be coupled by the bracket 40 so that the rotation of the fastening shaft 221 is restrained. In this case, the doorframe 20 may be rotatably connected to the door stile 30 by the pivot hinge apparatus 10 for a door, thereby enabling the opening and closing of the door. Accordingly, the doorframe 20 may be rotatably connected from the bracket 40, and a support portion 41 may be disposed at the upper end of the doorframe 20 to stably guide rotation from the bracket 40.

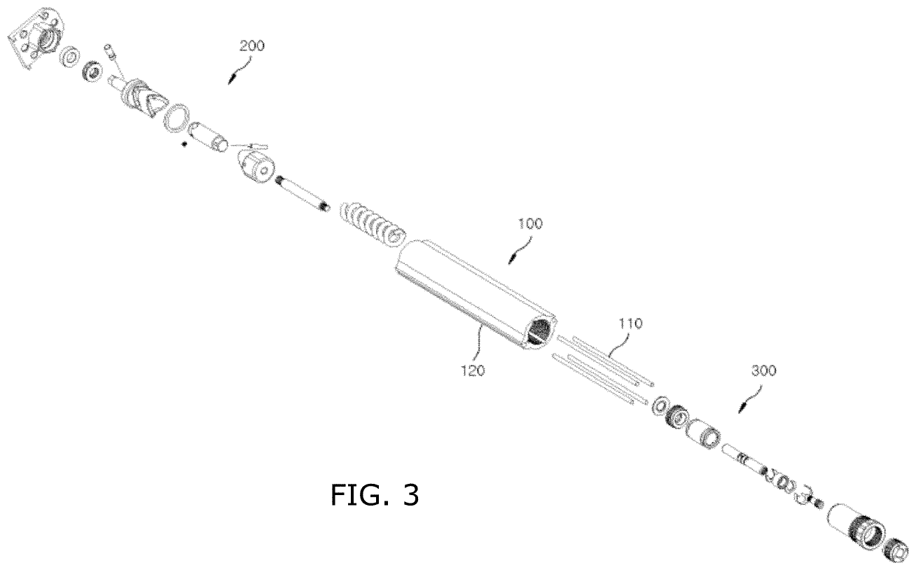

Referring to FIG. 3, the pivot hinge apparatus 10 for a door according to the embodiment of the present invention may basically include a torsion device 200 that is installed in the doorframe 20 (see FIGS. 1 and 2).

The torsion device 200 may include: a first cam member 220 configured such that first and second sliding portions 222 and 223 configured to guide vertical sliding with respect to rotation movement are disposed in upper and lower directions; and a second cam member 230 disposed to be slidable vertically by rotation relative to the first cam member 220 by a third sliding portion 231 that comes into contact with the first sliding portion 222, and configure to restrain the third sliding portion 231 and the first sliding portion 222 from being separated from each other in such a manner that a fourth sliding portion 232 is guided to the second sliding portion 223.

The pivot hinge apparatus 10 for a door according to the embodiment of the present invention is installed in the doorframe 20 (see FIGS. 1 and 2), and may further include a casing 100 inside which the torsion device 200 is installed. In this case, the torsion device 200 may be fastened to the door stile 30 (see FIGS. 1 and 3) by the fastening shaft 221 provided on the first cam member 220 and protruding to one end, and may generate restoring force so that the door is closed by a spring 250.

The casing 100 is installed and fastened in the doorframe 20 (see FIGS. 1 and 2). A plurality of guide bars 110 is disposed perpendicular to the inner surface of the torsion device 200 in order to guide the second cam member 230 to be described later through the vertical sliding in the torsion device 200. A plurality of coupling parts 120 may be provided to be coupled to a fastening member 210 by bolting or the like in the torsion device 200.

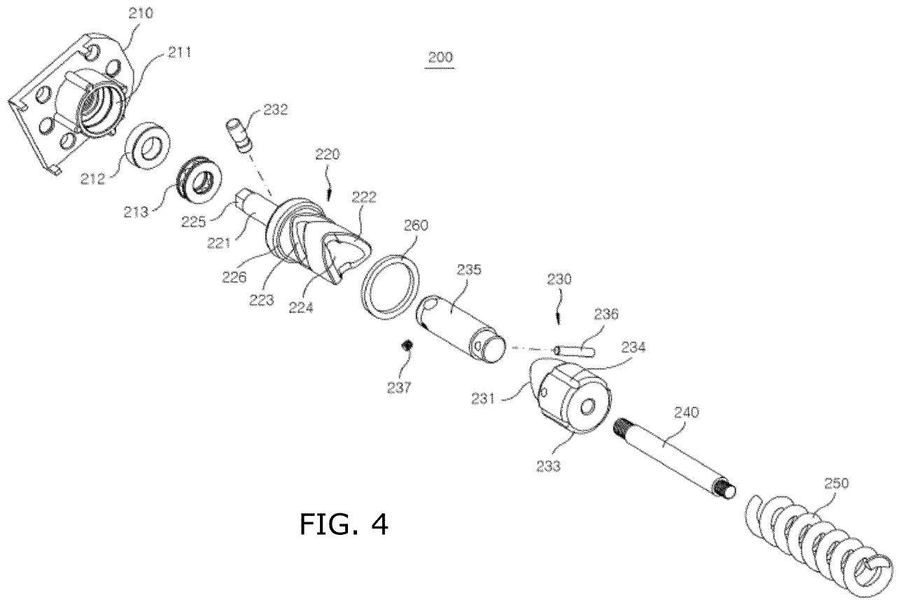

Referring to FIGS. 3 and 4, the torsion device 200 may further include the fastening member 210, a connection shaft 240 and a spring 250 in addition to the above-described first and second cam members 220 and 230.

The fastening member 210 is coupled to an end of the casing 100, and is fastened to an end of the doorframe 20 (see FIGS. 1 and 2). The fastening shaft 221 of the first cam member 220 protrudes through the fastening member 210. To couple and fasten the fastening member 210 to the casing 100 and the doorframe 20, there may be used various methods such as bolting, screw coupling or fitting.

The fastening member 210 may be provided with a mounting portion 211 configured to allow the first cam member 220 to be mounted via a bearing 213 so that the first cam member 220 allows the fastening shaft 221 to protrude, and the casing 100 may be fastened in the state of having been inserted into the outside of the mounting portion 211. A spacer 212, together with the bearing 213 configured to rotatably support the fastening shaft 221, may be disposed in the mounting portion 211.

The first cam member 220 is provided such that the fastening shaft 211 protrudes through the fastening member 210, and the first and second sliding portions 222 and 223 configured to provide guiding through vertical sliding may be formed in the upper and lower portions of the first cam member 220. A polygonal tip 225 may be formed on the fastening shaft 211 in order to provide fastening. A stop protrusion 226 may be formed on the outer circumferential surface of the first cam member 220, and a ring member 260 may be mounted on the stop protrusion 226.

The first cam member 220 may be provided such that the fastening shaft 221 is disposed perpendicular to one end thereof, a mounting groove 224 open to the other end is formed through the center thereof, the first sliding portion 222 including an inclined sliding surface is provided at the other end thereof, and the second sliding portion 223 stacked on the first sliding portion 222 and including an inclined sliding surface is formed to open the mounting groove 224. In this case, the term “inclined” means not only linear inclination but also inclination attributable to curvature. An inclined direction does not necessarily mean only one direction, i.e., a downward direction or an upward direction. It means a mixture of downward and upward directions, as in the letter “V,” a mixture of upward and downward directions, as in the letter an inverted “V,” a mixture of various directions, or a mixture including a horizontal portion.

When the first cam member 220 is rotated by the opening and closing operation of the door, the first cam member 220 slides the second cam member 230 downward, and thus the spring 250 is compressed and has restoring force. In order to have appropriate restoring force for each section, the sliding surfaces of the first and second sliding portions 222 and 223 may be each formed to have a different curvature or different inclination. Such a sliding surface may have various shapes, including the “V” shape as in this embodiment, to perform the above operation.

The second cam member 230 comes into contact with and is guided by each of the first and second sliding portions 222 and 223, and thus it is coupled to be restrained from being separated from the first cam member 220 in a vertical direction and is disposed to perform vertical sliding by relative rotation to the first cam member 220 in the state of being restrained from being rotated within the casing 100.

The second cam member 230 may include: a connection body 233 configured such that an inclined third sliding portion 231 is provided at one end thereof to come into contact with the first sliding portion 222; and an insertion shaft 235 provided to protrude from one end of the connection body 233, slidably fitted into the mounting groove 224, and configured to apply braking a speed difference attributable to damping force in such a manner that the fourth sliding portion 232 protruding through a side comes into contact with the second sliding portion 223. An inclined direction does not necessarily mean only one direction, i.e., a downward direction or an upward direction. It means a mixture of downward and upward directions, as in the letter “V,” a mixture of upward and downward directions, as in the letter an inverted “V,” a mixture of various directions, or a mixture including a horizontal portion. Furthermore, the speed difference may mean the difference between the return speed attributable to the restoring force by the spring 250 provided to the second cam member 230 and the return speed allowed by the damping force of the damping device 300 provided to the second cam member 230. Furthermore, the braking may mean attenuating the action attributable to such a speed difference.

The third sliding portion 231 is shaped such that it comes into contact with the first sliding portion 222 and when the door is opened, the second cam member 230 moves downward and has restoring force attributable to the compression of the spring 250. It will be apparent that it may have various shapes, including the “V” shape as in this embodiment.

A sliding coupling groove 234 configured to be seated on the guide bar 110 may be formed in the outer circumferential surface of the connection body 233 to be slidably coupled within the casing 100 in the vertical direction. Furthermore, the insertion shaft 235 is fastened to the connection body 233 in such a manner that the first fastening pin 236 is inserted into the insertion shaft 235 and the connection body 233 in the state in which the insertion shaft 235 has been inserted into the connection body 233. However, the method by which the insertion shaft 235 is fastened to the connection body 233 is not limited to the above method, but the insertion shaft 235 may be fastened to the connection body 233 by any one of various methods such as bolting, welding, screw coupling, and the like.

The fourth sliding portion 232 may have any one of various shapes such as a protrusion shape, a pin shape, a roller shape, and the like. The fourth sliding portion 232 is fastened to the insertion shaft 235 in such a manner that a second fastening pin 237 is inserted into the fourth sliding portion 232 and the insertion shaft 235 in the state in which the fourth sliding portion 232 has been inserted into the insertion shaft 235. However, the method by which the fourth sliding portion 232 is fastened to the insertion shaft 235 is not limited to the above method, but the fourth sliding portion 232 may be fastened to the insertion shaft 235 by any one of various methods such as bolting, welding, screw coupling, and the like. The fourth sliding portion 232 is slidably supported on the second sliding portion 223, thereby maximally restraining the third sliding portion 231 from being separated from the first sliding portion 222.

The connection shaft 240 is coupled to the second cam member 230, and extends vertically. The connection shaft 240 may be coupled to the second cam member 230 by any one of various methods such as screw coupling, a fastening pin, and the like, may be vertically fastened to the second cam member 230, and may be integrated with the second cam member 230.

The spring 250 is, for example, a compression spring, and is installed on the connection shaft 240 in order to provide elastic force to the second cam member 230 so that the second cam member 230 comes into close contact with the first cam member 220. The spring 250 may be disposed between the second cam member 230 and the damping device 300 in the state of having been inserted into the connection shaft 240. Meanwhile, when the damping device 300 is omitted, one end of the casing 100 may be blocked by a support cap configured to support the connection shaft 240 and the spring 250.

Although the torsion device 200 may be installed alone in the casing 100, the damping device 300 together with the torsion device 200 may be installed in order to provide damping force to the connection shaft 240, as in the present embodiment.

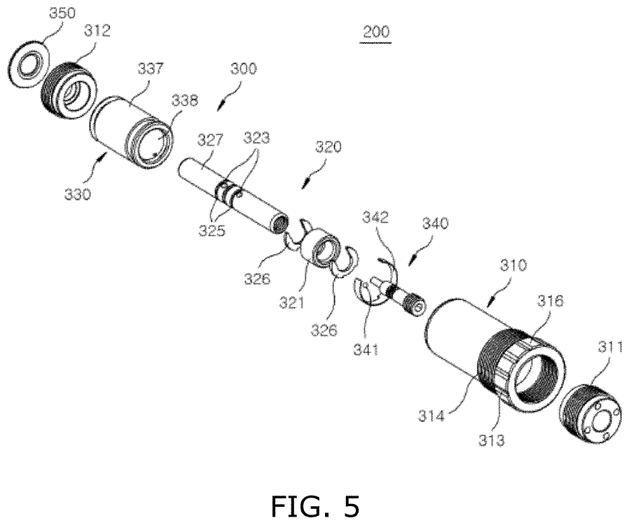

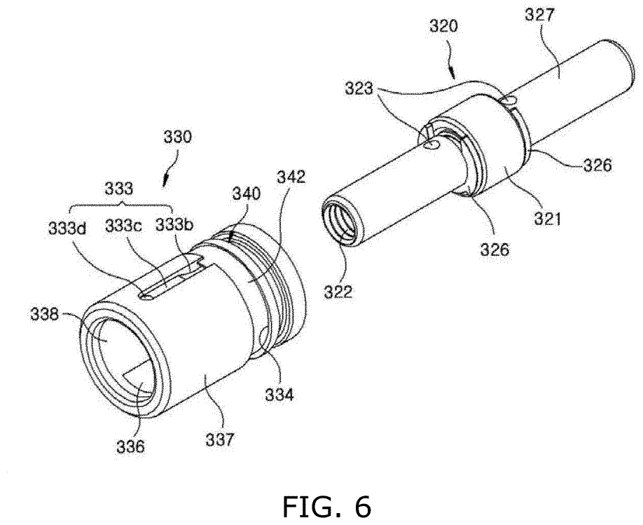

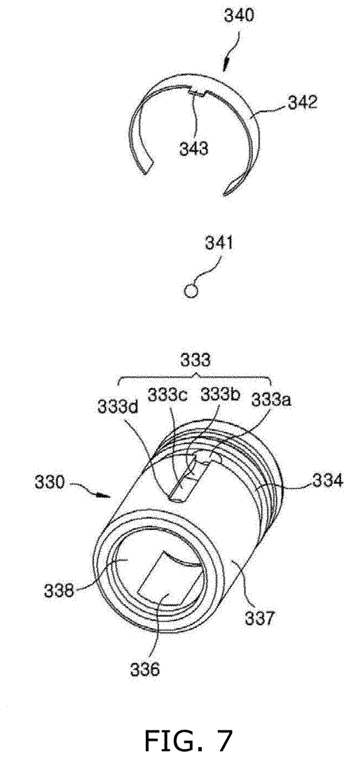

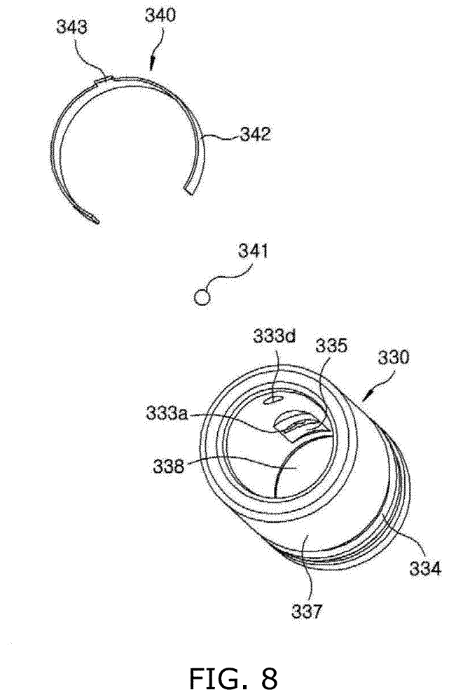

Referring to FIGS. 3, and 5 to 8, the damping device 300 includes, for example, a damping housing part 310, a piston 320, a damping chamber 330, and a one-way control unit 340, which will be described with reference to the accompanying drawings.

The damping housing part 310 may be filled with a working fluid, e.g., oil, and first and second sealing parts 311 and 312 may be provided at both ends of the damping housing part 310 in order to perform sealing. In this case, the first sealing part 311 may be provided at one end of the damping housing part 310 in an integrated manner, as in the present embodiment. As another example, the first sealing part 311 may be fabricated separately from the damping housing part 310, and may be coupled to the damping housing part 310. A through hole (not shown) may be formed to allow the piston 320 to pass therethrough. The second sealing part 312 may be fastened to a female screw portion formed on the inside of the other end of the damping housing part 310 by screw coupling, as in the present embodiment. As another example, the second sealing part 312 may be integrated with the damping housing part 310, may be provided with a through hole (not shown) to allow the piston 320 to pass therethrough, and may be provided with a sealing member, such as an O-ring, in order to maintain sealing on a coupling part with another component. A sealing member, such as an O-ring, may be disposed in a portion requiring sealing in the pivot hinge apparatus 10 for a door. Furthermore, the damping housing part 310 is provided with stop protrusions 313 to be inserted into and caught in the casing 100. A thrust bearing 350 is interposed between the second sealing part 312 and the spring 250.

The damping housing part 310 may be provided with a first male screw portion 314 in order to be screwed into the casing 100, and a knob 316 may protrude from an end of the casing 100 in order to allow gripping to be performed to perform rotation for screw fastening.

The piston 320 is inserted into the damping housing part 310 through the second sealing part 312, is provided with a head 321 in order to receive the pressure of a working fluid, and is coupled to the connection shaft 240, for example, by screw coupling. As an example, the piston 320 may be directly connected to the connection shaft 240. As another example, the piston 320 may be connected to the connection shaft 240 via a connection member.

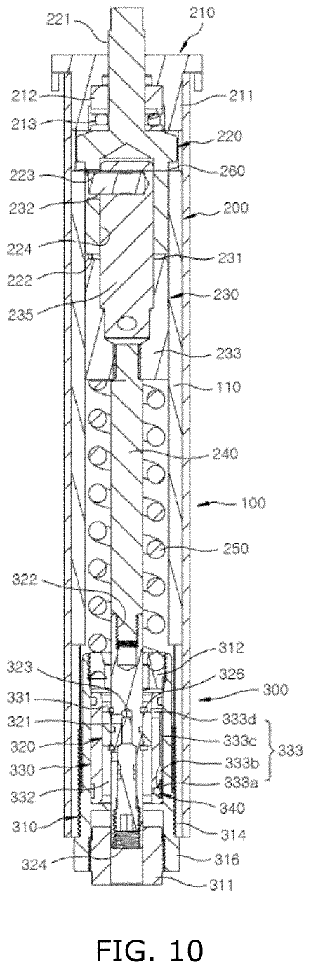

The piston 320 may be provided such that a piston rod 327 extends on both sides of the head 321. Both ends of the piston 320 may be slidably coupled to the first and second sealing parts 311 and 312. In order to improve the formation or assembly of the head 321, fastening members 326 are fitted into fitting groove 325 formed on both sides of the piston rod 327 around the head 321, and thus the head 321 is fastened to be restrained from being moved by the fastening members 326. A bypass passage 323 configured to connect both sides of the head 321 in order to bypass the head 321, so that pressure may be adjusted between the first and second spaces 331 and 332 of the damping chamber 330 and the degree of opening of the bypass passage 323 may be adjusted by a damping adjustment bolt 324 (see FIG. 10) screw-coupled to one end exposed from the first sealing part 311. The damping adjustment bolt 324 may adjust the degree of opening or closing of the bypass passage 323 through its tightening and loosening. Damping force may be adjusted by adjusting the amount of working fluid to be passed therethrough, thereby allowing damping speed to be adjusted. When a jig is allowed to be inserted for rotation, a straight groove, a cross groove, a wrench groove, or the like may be formed.

The damping chamber 330 may include a body 337, a main passage 333, and a mounting groove 334.

The head 321 of the piston 320 is inserted into the body 337, and is fastened into the damping housing part 310. The internal space 338 of the body 337 is filled with the working fluid, and is divided into first and second spaces 331 and 332 close to the first and second sealing parts 311 and 312 by the head 321. The main passage 333 configured to connect the first and second spaces 331 and 332 is formed and provide a working fluid path between the first and second spaces 331 and 332 for damping, and the mounting groove 334 may be formed through the outer surface of the body 337. The body 337 may be composed of a cylindrical hollow member having both open ends, and both ends thereof may be fastened inside the damping housing part 310 by the first and second sealing parts 311 and 312. The body 337 or the piston 320 may be configured to allow the movement of the working fluid in various manners or structures in order to prevent damage caused by the excessive pressure of the working fluid when it is necessary for the door to be closed after being opened.

The main passage 333 may be provided such that a ball seat hole 333a configured to connect the second space 332 with the outside and to allow the ball 341 of the one-way control unit 340 to be seated thereon from the outside in order to perform blocking is formed in the side of the body 337, a passage hole 333d configured to connect the first space 331 with the outside is formed in the side of the body 337, and connection depressions 333b and 333c configured to connect the ball seat hole 333a and the passage hole 333d with each other are formed through the outer surface of the body 337. The connection depressions 333b and 333c may be formed through the outer surface of the body 337 to be connected to the ball seat hole 333a and directed toward the passage hole 333d, and may include an operation passage 333b configured such that the depth thereof increases as it becomes close to the ball seat hole 333a and a connection passage 333c formed through the outer surface of the body 337 to connect the operation passage 333b and the passage hole 333d to each other. Accordingly, the main passage 333 may provide a movement passage between the first and second spaces 331 and 332 to the working fluid that reciprocates by itself without the help of another passage and is isolated from the head 321.

The mounting groove 334 may be formed through the outer surface of the body 337 so that an elastic portion 342 configured to elastically support the ball 341 of the one-way control unit 340 to be seated in the ball seat hole 333a is mounted. The mounting groove 334 may be formed along the circumference of the outer circumferential surface of the body 337 in order to intersect the ball seat hole 333a so that the elastic portion 342 stably supports the ball 341.

The damping chamber 330 may be provided such that a first adjustment passage 335 configured to be connected to the ball seat hole 333a and to adjust the initial closing speed of the door is formed through the inner surface of the body 337 and at least one second adjustment passage 336 is formed through the inner surface so that the working fluid moves between the first and second spaces 331 and 332 by bypassing the head 321.

The first adjustment passage 335 is formed to have a length larger than the thickness of the head 321 and to include the ball seat hole 333a, thereby being connected to the ball seat hole 333a and forming an initial speed adjustment section.

The second adjustment passage 336 may include one or more adjustment passages as in the present embodiment. When the head 321 of the piston 320 moves inside the damping chamber 330, the working fluid to which pressure is applied by the head 321 moves from the first space 331 to the second space 332 or in the opposite direction by bypassing the head 321. By the formation of the second adjustment passage 336, it is made possible to adjust damping force and/or closing speed for each section with respect to the opening/closing area of the door corresponding to the location of the head 321 in the damping chamber 330. Furthermore, the second adjustment passage 336 is formed to have a length larger than the thickness of the head 321. The location and length of the second adjustment passage 336 in the damping chamber 330 may be determined by considering the location of the head 321 corresponding to a section requiring the adjustment of the closing speed of the door. Furthermore, when the second adjustment passage 336 includes a plurality of second adjustment passages, the second adjustment passages 336 may be formed to partially overlap each other with respect to the reciprocating direction of the head 321 so that damping force change sections are naturally connected to each other. As another example, the second adjustment passages 336 may be formed to entirely overlap each other. As another example, the second adjustment passages 336 may be formed not to overlap each other so that damping force change sections are intermittent. Alternatively, the second adjustment passage 336 may include a single second adjustment passage. The sectional area of the second adjustment passage 336 may be determined by considering the bypass amount of working fluid required for damping control.

The one-way control unit 340 allows the main passage 333 to be blocked by the ball 341 configured to be seated in the main passage 333 from the outside, and allows the working fluid to move in one direction between the first and second spaces 331 and 332 when the piston 320 moves in such a manner that the elastic portion 342 configured to elastically support the ball 341 to be seated in the main passage 333 is mounted in the mounting groove 334. As described above, the one-way control unit 340 allows movement in a direction that reduces damping force, e.g., in one direction from the second space 332 to the first space 331, when the door is opened, as in the present embodiment, as an example. The main passage 333 is opened and closed in one direction by limiting the movement direction of the working fluid by using the ball 341 elastically supported by the elastic portion 342 similar to a leaf spring. The elastic portion 342 may be provided so that a location fixing protrusion 343 seated in the operation passage 333b may protrude so as to maintain a location for stably and elastically supporting the ball 341.

The operation of the pivot hinge apparatus for a door according to the present invention will be described below.

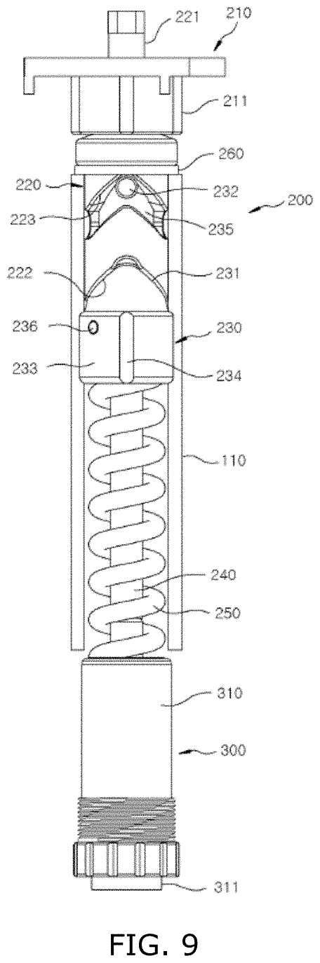

Referring to FIGS. 9 and 10, when the angle that the door forms with respect to the door stile 30 (see FIGS. 1 and 2) is 0 degrees due to the closing of the door, elastic force is provided from the spring 250 of the torsion device 200 to the second cam member 230, and the second cam member 230 maintains the state in which the door has been closed through the coupling to the first cam member 220.

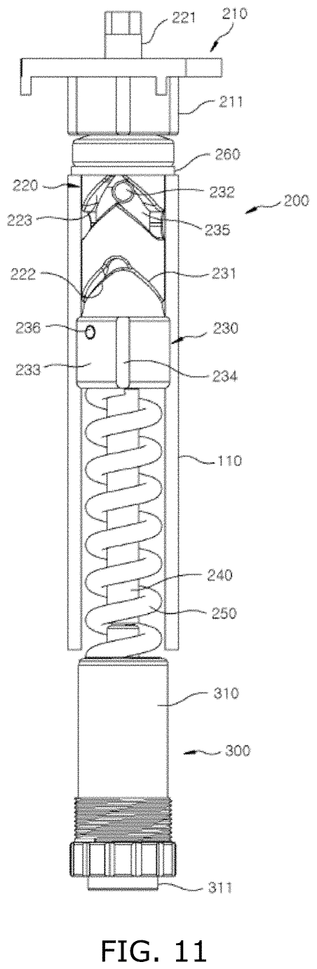

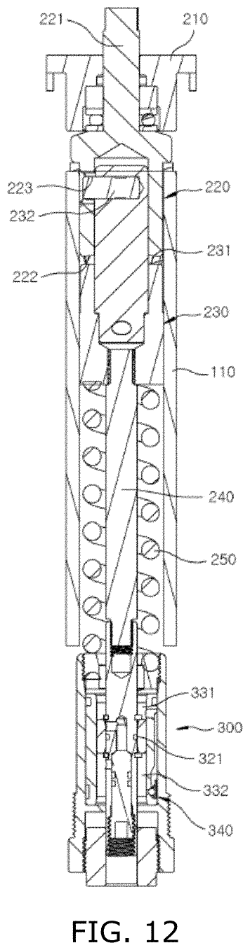

Referring to FIGS. 11 and 12, when the opened angle of the door is, for example, 10 degrees with respect to the door stile 30 (see FIGS. 1 and 2), the second cam member 230 is rotated from the first cam member 220 by the opening force of the door, and thus the second cam member 230 is slid by the sliding of the first and second sliding portions 222 and 223 and the third and fourth sliding portions 231 and 232. Accordingly, the spring 250 is compressed, and thus elastic force is accumulated in the spring 250.

In this case, in the case of the opening operation of the door, the piston 320 of the damping device 300 is moved along with the second cam member 230, and thus the compression of the working fluid to the second space 332 is started by the piston 320. In this case, the working fluid in the second space 332 opens a check valve corresponding to the one-way control unit 340, passes through the main passage 333, and moves to the first space 331, thereby providing damping force for the door.

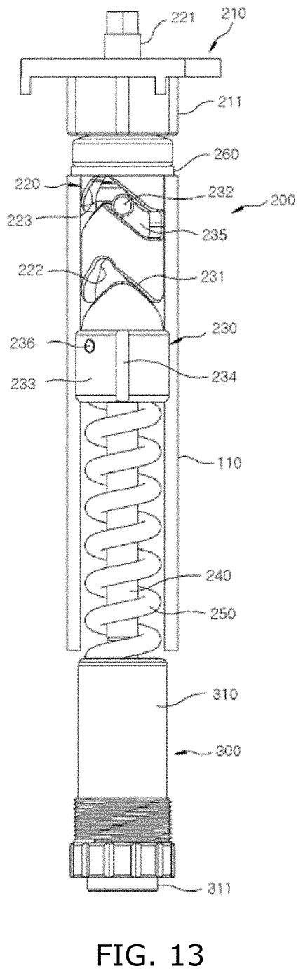

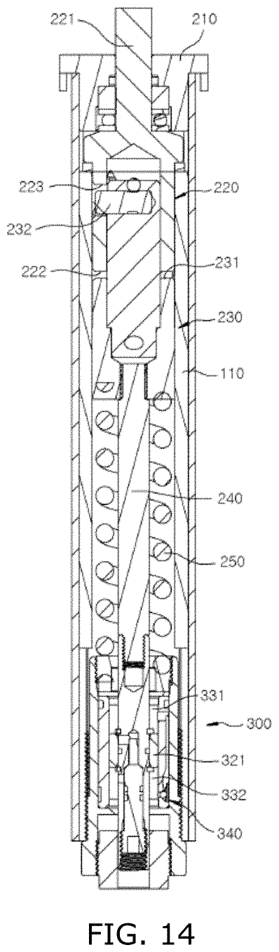

Referring to FIGS. 13 and 14, when the opened angle of the door is, for example, 30 degrees with respect to the door stile 30 (see FIGS. 1 and 2), elastic force is further accumulated in the spring 250 by the downward sliding of the second cam member 230, and damping force provided from the damping device 300 by the opening and closing operation of the door is also provided to the door.

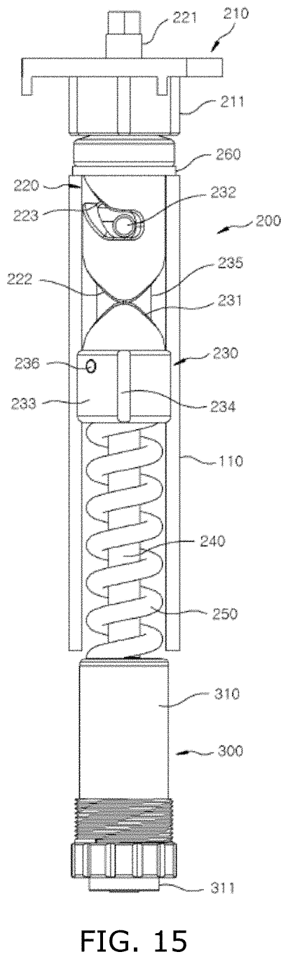

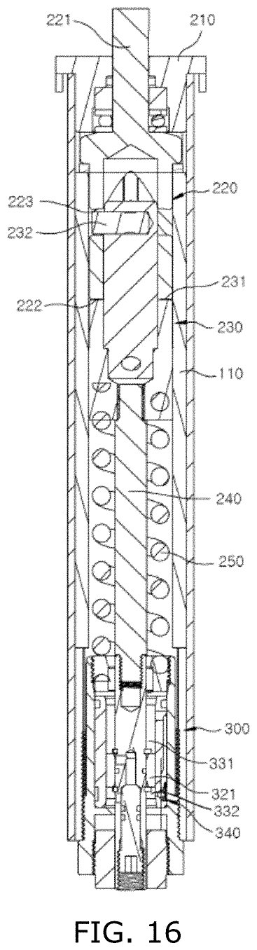

Referring to FIGS. 15 and 16, when the opened angle of the door is, for example, 90 degrees with respect to the door stile 30 (see FIGS. 1 and 2), elastic force attributable to the spring 250 is accumulated in the door. Accordingly, when external force is removed from the door, the accumulated elastic force slides the second cam member 230 upward, and thus the second cam member 230 together with the door is rotated around the first cam member 220 and the door is closed. As shown in FIGS. 13 and 14, when the opened angle of the door is, for example, about 30 degrees, the speed at which the damping force of damping device 300 restores the second cam member 230 together with the connection shaft 240 upward is lower than the speed at which the door is closed by elastic force attributable to the spring 250, and thus the first cam member 220 is to be separated from the second cam member 230. In this case, the fourth sliding portion 232 comes into close contact with the second sliding portion 223 and acts as a brake, and thus the state in which the first cam member 220 and the second cam member 230 come into close contact with each other is maintained. Accordingly, anyone of the first cam member 220 and the second cam member 230 is prevented from running idle, and damping force together with restoring force is appropriately transferred to the door, thereby enabling the operation of closing the door to be stably performed.

Furthermore, as shown in FIGS. 11 and 12, when the difference between the speed at which the door is closed by the restoring force of the spring 250 and the restoring speed of the second cam member 230 by damping force is reduced, braking action for the fourth sliding portion 232 and the second sliding portion 223 is eliminated, and thus the first and second cam members 220 and 230 slide naturally. Accordingly, the door is naturally closed by the restoring force of the spring 250 while being provided with damping force from the damping device 300.

As described above, according to the present invention, restoring force for closing is accurately transferred to the door, thereby improving the reliability of door operation.

Furthermore, according to the present invention, even when both the torsion device and the damping device are implemented by adding them to each other, the state in which the first cam unit and the second cam unit are engaged with each other is maintained despite a difference in speed attributable to damping force, and thus they are prevented from running idle, with the result that damping force is accurately transferred to the door, thereby improving the reliability of the operation of opening and closing the door and also providing safe use as well as convenient use to a user.

Although the present invention has been described with reference to the accompanying drawings, it will be apparent that various modifications and alterations may be made without departing from the technical spirit of the present invention. Therefore, the scope of the present invention should not limited to the above-described embodiments, but should be defined based on not only the appended claims but also equivalents to the claims.

What is claimed is:

1. A pivot hinge apparatus for a door, the pivot hinge apparatus comprising a torsion device configured to be mounted on a doorframe, wherein the torsion device comprises:
a first cam member formed such that first and second sliding portions configured to provide guiding through vertical sliding with respect to rotation movement are disposed in upper and lower directions; and
a second cam member disposed to be slidable vertically by rotation relative to the first cam member by a third sliding portion that comes into contact with the first sliding portion and configured to restrain the third sliding portion and the first sliding portion from being separated from each other in such a manner that a fourth sliding portion is guided to the second sliding portion.

2. The pivot hinge apparatus of claim 1, further comprising a casing disposed in the doorframe and configured such that the torsion device is disposed therein;
wherein the torsion device is fastened to a door stile by a fastening shaft provided on the first cam member and protruding to one end, and generates restoring force by a spring so that the door is closed.

3. The pivot hinge apparatus of claim 2, wherein the torsion device comprises:
a fastening member coupled to an end of the casing, fastened to an end of the doorframe, and configured such that the fastening shaft protrudes therefrom;
a connection shaft coupled to the second cam member, and configured to extend vertically; and
a spring installed on the connection shaft in order to provide elastic force to the second cam member.

4. The pivot hinge apparatus of claim 3, wherein the fastening member is provided with a mounting portion configured to perform mounting via a bearing so that the first cam member allows the fastening shaft to protrude, and the casing is fastened in a state of having been inserted into an outside of the mounting portion.

5. The pivot hinge apparatus of claim 2, wherein the first cam member is configured such that the fastening shaft is provided to be perpendicular to one end thereof, a mounting groove open at a remaining end thereof is formed through a center thereof, a first sliding portion including an inclined sliding surface is provided at the remaining end, and a second sliding portion stacked on the first sliding portion and including an inclined sliding surface is formed to open the mounting groove.

6. The pivot hinge apparatus of claim 3, wherein the first cam member is configured such that the fastening shaft is provided to be perpendicular to one end thereof, a mounting groove open at a remaining end thereof is formed through a center thereof, a first sliding portion including an inclined sliding surface is provided at the remaining end, and a second sliding portion stacked on the first sliding portion and including an inclined sliding surface is formed to open the mounting groove.

7. The pivot hinge apparatus of claim 4, wherein the first cam member is configured such that the fastening shaft is provided to be perpendicular to one end thereof, a mounting groove open at a remaining end thereof is formed through a center thereof, a first sliding portion including an inclined sliding surface is provided at the remaining end, and a second sliding portion stacked on the first sliding portion and including an inclined sliding surface is formed to open the mounting groove.

8. The pivot hinge apparatus of claim 5, wherein the second cam member comprises:
a connection body provided with an inclined third sliding portion at one end thereof to come into contact with the first sliding portion; and
an insertion shaft provided to protrude from one end of the connection body, coupled onto the mounting groove to be slidable, and configured to apply braking for a difference in speed attributable to damping force in such a manner that the fourth sliding portion protruding through a side comes into contact with the second sliding portion.

9. The pivot hinge apparatus of claim 3, further comprising a damping device installed in the casing in order to provide damping force to the connection shaft;
wherein the damping device comprises:
a damping housing part filled with a working fluid, provided with first and second sealing parts at both ends thereof in order to achieve sealing, and fastened in the casing;
a piston inserted into the damping housing part through the second sealing part, provided with a head in order to receive pressure of the working fluid, and connected to the connection shaft;
a damping chamber configured such that a body into which the head is inserted is fastened to an inside of the damping housing part, an internal space of the body is divided into first and second spaces in contact with the first and second sealing parts by the head, a main passage connecting the first and second spaces to each other is formed and provides a working fluid path between the first and second spaces to achieve damping, and a mounting groove is formed through an outer surface of the body; and
a one-way control unit configured to allow the main passage to be blocked by a ball seated in the main passage from an outside, and to allow the working fluid to move in one direction between the first and second spaces while the piston moves in such a manner that an elastic portion configured to elastically support the ball to be seated in the main passage is mounted in the mounting groove.

10. The pivot hinge apparatus of claim 4, further comprising a damping device installed in the casing in order to provide damping force to the connection shaft;
wherein the damping device comprises:
a damping housing part filled with a working fluid, provided with first and second sealing parts at both ends thereof in order to achieve sealing, and fastened in the casing;
a piston inserted into the damping housing part through the second sealing part, provided with a head in order to receive pressure of the working fluid, and connected to the connection shaft;
a damping chamber configured such that a body into which the head is inserted is fastened to an inside of the damping housing part, an internal space of the body is divided into first and second spaces in contact with the first and second sealing parts by the head, a main passage connecting the first and second spaces to each other is formed and provides a working fluid path between the first and second spaces to achieve damping, and a mounting groove is formed through an outer surface of the body; and
a one-way control unit configured to allow the main passage to be blocked by a ball seated in the main passage from an outside, and to allow the working fluid to move in one direction between the first and second spaces while the piston moves in such a manner that an elastic portion configured to elastically support the ball to be seated in the main passage is mounted in the mounting groove.

11. The pivot hinge apparatus of claim 7, wherein the piston is configured such that both ends thereof are slidably coupled to the first and second sealing parts, the head is slidably coupled to a piston rod, the head is fastened to be restrained by the fastening member from moving in such a manner that fastening members are fitted into fitting grooves formed in both sides of the head in the piston rod, a bypass passage configured to connect both sides of the head to each other is formed to bypass the head, and a degree of opening of the bypass passage is adjusted by a damping adjustment bolt screw-coupled to one end exposed from the first sealing part.
